(19) United States
(12) Patent Application Publication
(10) Pub. No.: US 2002/0161082 A1
(43) Pub. Date: Oct. 31, 2002

(54) Copolyesters with antistatic properties and high clarity

(75) Inventors: Douglas Stephens McWilliams, Kingsport, TN (US); Harold Eugene Dobbs, Kingsport, TN (US); Scott Arnold Hanson, Longview, TX (US); Emily Tedrow Bell, East Longmeadow, MA (US)

Correspondence Address: NEEDLE & ROSENBERG P C, 127 PEACHTREE STREET N E, ATLANTA, GA, 30303-1811, US

(73) Assignee: Eastman Chemical Company

(21) Appl. No.: 10/136,222

(22) Filed: Apr. 29, 2002

Related U.S. Application Data
(62) Division of application No. 09/454,019, filed on Dec. 3, 1999.
(60) Provisional application No. 60/112,907, filed on Dec. 18, 1998.

(51) Int. Cl. C08L 1/00

(52) U.S. Cl. 524/159

(57) ABSTRACT

A novel copolyester composition is provided comprising a copolyester having a melting point less than 250° C. and a quaternary ammonium salt having thermal stability at temperatures greater than 200° C. wherein the composition is characterized as having both antistatic and clarity properties.

### CROSS-REFERENCE TO RELATED APPLICATIONS

This application claims priority upon provisional application Serial No. 60/112,907 filed Dec. 18, 1998, and the 60/112,907 application is herein incorporated by this reference in its entirety.

### FIELD OF THE INVENTION

The present invention relates to a composition comprising a copolyester having a melting point less than 250° C. and a specified antistatic agent. The composition may be blended with the same or other homo- or copolyester to provide films, sheeting, and thermoformed articles having excellent clarity and antistatic properties.

### BACKGROUND OF THE INVENTION

Polyesters are widely used as extrusion and injection molding resins for applications such as fibers, films, sheeting, food and beverage containers and the like. Commonly used polyesters include polyethylene terephthalate (PET), poly-1,4-butylene terephthalate (PBT), and poly-1,4-cyclohexanedimethylene terephthalate (PCT). Copolyesters are frequently used when special properties such as lower processing temperatures, clarity, or inhibited crystallization are needed. Polyesters like most other synthetic polymers are poor conductors of electricity. Thus, during extrusion, processing, or handling of such polymers, static charges may accumulate. This is especially true under conditions of low relative humidity. Static charge is highly undesirable in that it can cause material handling problems during processing, lead to shocks when molded parts are handled, lead to the collection of dust on packages, and cause damage to sensitive electronic parts that are stored in plastic packaging due to dissipation of static charge. Therefore, it would be advantageous if thermoplastic polyesters could be provided which had good antistatic properties.

There are many antistat additives available for use in thermoplastic polymers including polyesters. To be effective as an antistat, some of these additives need to be used in such high concentration that they impart an undesirable cloudy appearance to the film, sheet, or molded article.

### SUMMARY OF THE INVENTION

In accordance with this invention, there are provided compositions comprising certain antistat agents and copolyesters that provide an unexpected combination of antistat performance and clarity in films, sheets or molded articles produced from the compositions. The amount of antistatic agent utilized is from about 0.6 to about 1.5 weight percent, based on the total composition. Any copolyester having a melting point less than 250° C. may be utilized.

Preferably the copolyester utilized is based on terephthalic acid, naphthalenedicarboxylic acid and/or 1,4-cyclohexanedicarboxylic acid and contains about 10 to about 90 mole % ethylene glycol and about 90 to about 10 mole % of other glycol(s).

The antistatic agents are quaternary ammonium salts having thermal stability at temperatures greater than 200° C. Exemplary are quaternary ammonium alkyl benzene sulfonate salts, quaternary ammonium alkane sulfonate salts, and the like. Specific examples include octyl dimethyl hydroxyethyl ammonium dodecylbenzene sulfonate and octyl dimethyl hydroxyethyl ammonium methane sulfonate. Other compounds of this type are listed in U.S. Pat. Nos. 4,904,825, 5,053,531 and 5,187,214. Some of these materials are available commercially from BASF Corporation.

### DETAILED DESCRIPTION OF THE INVENTION

The novel compositions of the present invention comprise any copolyester having a melting point less than 250° C. and an antistatic agent. As used herein, copolyester is any polyester containing two or more types of repeat unit. The antistatic agent is present in an amount of from about 0.6 to about 1.5 weight %, more preferably in an amount of from about 0.75 to about 1.5 weight %, based on the final composition.

Preferred copolyesters nonexclusively include linear, thermoplastic, crystalline, or amorphous copolyesters produced by conventional polymerization techniques from one or more diol(s) with two or more dicarboxylic acids, or one or more dicarboxylic acid(s) with two or more diols. Exemplary diol components of the described copolyesters may be selected from ethylene glycol, neopentyl glycol, 1,4-cyclohexanedimethanol, 1,2-propanediol, 1,3-propanediol, 1,4-butanediol, 1,6-hexanediol, 1,2-cyclohexanediol, 1,4-cyclohexanediol, 1,2-cyclohexanedimethanol, 1,3-cyclohexanedimethanol, Z,8-bis(hydroxymethyl)-tricyclo-[5.2.1.0]-decane wherein Z represents 3, 4, or 5; and diols containing one or more oxygen atoms in the chain, e.g. diethylene glycol, triethylene glycol, dipropylene glycol, tripropylene glycol, and the like. In general, these diols contain 2 to 18, preferably 2 to 8 carbon atoms. Cycloaliphatic diols can be employed in their cis or trans configuration or as mixtures of both forms.

Exemplary acid components (aliphatic, alicyclic, or aromatic dicarboxylic acids) of the linear copolyester are selected, for example, from terephthalic acid, isophthalic acid, 1,4-cyclohexanedicarboxylic acid, 1,3-cyclohexanedicarboxylic acid, succinic acid, glutaric acid, adipic acid, sebacic acid, 1,12-dodecanedioic acid, 2,6-naphthalenedicarboxylic acid and the like. In polymer preparation, it is often preferable to use a functional acid derivative thereof such as the dimethyl, diethyl, or dipropyl ester of the dicarboxylic acid. The anhydrides or acid halides of these acids also may be employed where practical. The linear copolyesters may be prepared according to copolyester forming conditions well known in the art. For example, a mixture of one or more dicarboxylic acids, preferably aromatic dicarboxylic acids, or ester forming derivatives thereof, and one or more diols may be heated in the presence of esterification and/or polyesterification catalysts at temperatures in the range of about 150° C. to about 300° C., and pressures of atmospheric to about 0.2 mm Hg. Normally, the dicarboxylic acid(s) or derivative thereof is esterified or transesterified with the diol(s) at atmospheric pressure and at a temperature at the lower end of the specified range. Polycondensation then is effected by increasing the temperature and lowering the pressure while excess diol is removed from the mixture.

Exemplary copolyesters in the practice of this invention include terephthalate, naphthalenedicarboxylate and 1,4-cyclohexanedicarboxylate copolyesters containing ethylene glycol and 1,4-cyclohexanedimethanol (CHDM) moieties. The CHDM concentrations generally contain from about 10 to about 60 mole %. The copolyesters generally contain at least 80 mole % of terephthalic, naphthalenedicarboxylic, or 1,4-cyclohexanedicarboxylic acid moieties. Mixtures of the acids may be used if desired. In addition, from 0 to about 20 mole % of other acids may be used. Preferred modifying acid(s) include those containing about 4 to about 40 carbon atoms such as succinic, glutaric, adipic, sebacic, suberic, isophthalic acids and the like, and mixtures thereof. Modifying acids are defined herein as acids that are not present as a majority of the acid component of the copolyester.

In addition, other gycols may be used in amounts of from about 10 to about 90 mole %. The other glycol(s) include those containing about 3 to about 12 carbon atoms such as 1,3-propanediol, propylene glycol, 1,4-butanediol, 1,6-hexanediol, neopentyl glycol, 2,2,4,4-tetramethyl-1,3-cyclobutanediol, diethylene glycol, polyethylene glycol, and the like, and mixtures thereof.

Preferred copolyesters for use herein comprise about 100 mole percent terephthalic acid, about 40 to about 90 mole percent ethylene glycol, and about 10 to about 60 mole percent CHDM. More preferred are copolyesters comprising about 100 mole percent terephthalic acid, about 65 to about 75 mole percent ethylene glycol, and about 25 to about 35 mole percent CHDM.

Preferred copolyesters for use herein comprise about 100 mole percent terephthalic acid, about 40 to about 90 mole percent ethylene glycol, and about 10 to about 60 mole percent neopentyl glycol (NPG). More preferred are copolyesters comprising about 100 mole percent terephthalic acid, about 60 to about 80 mole percent ethylene glycol, and about 20 to about 40 mole percent NPG.

Preferred copolyesters for use herein comprise about 10 to about 50 mole percent isophthalic acid, about 50 to about 90 mole percent terephthalic acid, and about 100 mole percent CHDM. More preferred are copolyesters comprising about 15 to about 40 mole percent isophthalic acid, about 60 to about 85 mole percent terephthalic acid, and about 100 mole percent CHDM.

The mole percentages of the diol component of copolyester of the invention total 100 mole %. The mole percentages of the acid component of the copolyester of the invention total 100 mole %.

Small amounts of branching agents such as trimellitic acid, pyromellitic dianhydride, trimethylolpropane, pentaerythritol, and the like may be used. It is preferred that less than about 2 mole % of such branching agents may be used.

The CHDM and 1,4-cyclohexanedicarboxylic components may be in the cis form, the trans form, or a mixture of cis and trans isomers. The acid moiety may be derived from the acid or a suitable synthetic equivalent such as a lower alkyl ester. The dimethyl esters are widely used to make polyesters. The naphthalenedicarboxylate moiety will generally be derived from 2,6-naphthalenedicarboxylic acid or its lower alkyl esters containing 1 to 4 carbon atoms. However, other naphthalenedicarboxylic acid isomers or mixtures of isomers may be used if desired. The preferred isomers are the 2,6-, 2,7-,1,4- and 1,5- isomers.

The antistatic agents are quaternary ammonium salts having thermal stability at temperatures greater than 200° C. Exemplary are quaternary ammonium alkyl benzene sulfonate salts, quaternary ammonium alkane sulfonate salts, and the like. Specific examples include octyl dimethyl hydroxyethyl ammonium dodecylbenzene sulfonate and octyl dimethyl hydroxyethyl ammonium methane sulfonate. Other compounds of this type are listed in U.S. Pat. Nos. 4,904,825, 5,053,531 and 5,187,214. Further exemplary of the antistatic agents suitable for use herein are represented by the following formula:

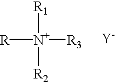

wherein R is a C₂-C₂ alkyl, preferably a C₈-C₁₈ alkyl, and R₁ is selected from the group consisting of C₁-C₂₂ alkyl and an alkyleneoxy radical, “Z” that may be represented by the formula, [—CH₂—C(A)H—O]ₓH, wherein A is hydrogen, methyl or ethyl, and x is an integer of from 1-5, e.g. hydroxyethyl, hydroxypropyl, hydroxybutyl, poly(ethyleneoxy) hydroxyethyl, poly(propyleneoxy) 2-hydroxypropyl, and poly(butyleneoxy) 2-hydroxybutyl. Preferably R₁ is selected from the group consisting of C₁-C₃ alkyl or C₈-C₁₈ alkyl, e.g. methyl, ethyl, n-propyl, isopropyl, octyl, decyl, dodecyl, hexadecyl, and octadecyl, or the alkyleneoxy radical Z wherein A is hydrogen or methyl and x is 1 to 3. Still more preferably, R₁ s a C₁-C₃ alkyl or alkylenenoxy radical Z wherein A is hydrogen and x is 1 to 2. When x is greater than 1, the sulfonate compound may be liquid, which makes it easier to handle.

R₂ in the above formula is selected from the group consisting of C₁-C₃ alkyl, e.g. methyl, ethyl, n-propyl and isopropyl, and the radical Z, wherein A and x are as defined with respect to R₁. Alternatively R₁ and R₂ may also join together to form a six-membered morpholino group.

R₃ in the above formula is a group represented by the alkylenoxy radical Z, wherein A and x are as defined with respect to R₁; and Y is the anion, R′SO₃, wherein R′ is a C₁-C₁₈alkyl, preferably a C₁-C₂alkyl, e.g. methyl and ethyl or a C₈-C₁₈ alkylphenyl, preferably a C₁₀-C₁₃ alkylphenyl. Preferably, the alkyl phenyl is a para-alkylphenyl.

With respect to R, R₁, and R′, the term alkyl denotes a univalent, essentially saturated branched or straight chained alkyl group. Representative of such alkyl groups include methyl, ethyl, propyl, butyl, pentyl, hexyl, isohexyl, heptyl, octyl, nonyl, decyl, undecyl, dodecyl, tridecyl, tetradecyl, pentadecyl, hexadecyl, heptadecyl, octadecyl, soya, eicosyl and the like. When derived from naturally occurring materials, the group R, R₁, and R′ may contain a small amount of unsaturation and may be comprised of a mixture of alkyl groups. For example, commercially available dodecyl benzene sulfonic acid is a benzene sulfonic acid in which the alkyl substituent on the benzene ring is a mixture of C₁₀-C₁₃ alkyl groups, the nominal number of carbon atoms being about 12.

It has been found that the copolyester compositions containing the antistatic agent can be readily prepared using any conventional blending equipment such as single screw extruders, twin screw extruders, Brabender Plastographs, Sigma blade mixers, and the like. In addition, the copolyester compositions can be prepared from a masterbatch, which is let down to the desired concentration. These compositions are generally prepared at melt temperatures of about 200 to about 250° C. Generally, it is desirable to use as low a processing temperature as possible since degradation of these antistat additives and a corresponding yellow tinted discoloration of the extrudate may be discernible at temperatures of about 250° C. and above. Single screw extrusion is the most common processing equipment used to produce film, sheet, and molded articles.

The copolyesters of this invention are well known and many of them are commercially available from Eastman Chemical Company. Methods for their preparation are described in U.S. Pat. Nos. 2,465,319 and 3,047,539. Useful copolyesters will have inherent viscosity values (I.V.) of about 0.5 to about 1.5 dl/g, preferably with values of about 0.6 to about 1.0 dl/g. Inherent viscosity is determined in a 60/40 (wt/wt) phenol/tetrachloroethane solution at a concentration of 0.5 grams per 100 ml at 25° C.

Melting point as defined herein is measured by DSC (differential scanning calorimetry) analysis. DSC measurements were made at a scan rate of 20° C./min.

The antistatic agents of the invention are thermally stable at temperatures in excess of 200° C. Thermal stability is weight loss of less than 5 weight percent when heated to temperatures up to about 275° C.

The agents described above have antistatic agent concentrations of about 0.6 to about 1.5 weight %, with preferred concentrations including about 0.75 to about 1.5 weight % in the final composition. Clear non-colored film, sheeting, or thermoformed articles will result from the use of these compositions.

Although not required, additives normally used in copolyesters may be used if desired. Such additives include colorants, dyes, pigments, fillers, antioxidants, stabilizers, flame retardants, impact modifiers, buffers and the like.

A preferred embodiment is one or more shaped articles made from one or more copolyesters of the invention. Even more preferably, the shaped article may be selected from the group consisting of films, fibers, foamed objects and molded objects. It is preferred that the shaped article is a film. This film may be produced by any method known in the art, for example, by a melt blowing process, a solvent casting process, a melt extrusion process, or a melt extrusion process followed by uniaxial or biaxial orientation.

Another preferred embodiment of this invention is a process for making the copolyester composition of this invention wherein the antistat agent of the invention is mixed or blended with the copolyester of the invention.

For the purposes of this invention, a masterbatch is as defined by one of ordinary skill in the art. More particularly, a masterbatch is a composition comprising a polymer and an antistatic agent where the antistat agent concentration is higher than desired in the final product, and which composition is subsequently let down in the same or other polymer to produce a final product with the desired concentration of antistatic agent.

The copolyester compositions of this invention are useful in applications where antistatic and clarity properties are required. The compositions are useful as monolayer film, monolayer sheet, as a layer(s) in multilayer film or multilayer sheet, and thermoformed articles produced from film or sheet such as clamshell packaging.

All percentages expressed herein refer to weight percentages unless otherwise specified.

This invention can be further illustrated by the following examples of preferred embodiments thereof, although it will be understood that these examples are included merely for purposes of illustration and are not intended to limit the scope of the invention unless otherwise specifically indicated.

### EXAMPLES

In the examples, the following is to be noted.

Larostat HTS 905A antistat is a quatemary ammonium sulfonate salt, sold under the registered trademark of BASF Corporation.

Eastar PETG 6763 is a copolyester based on terephthalic acid, ethylene glycol, and 1,4-cyclohexanedimethanol, produced and sold by Eastman Chemical Company.

The copolyester is PETG containing 12 mole % CHDM, 88 mole % ethylene glycol, and 100 mole % terephthalic acid.

### Example 1

A masterbatch consisting of 4.8 weight % Larostat HTS 905A antistat and 95.2 weight % of a polyethylene terephthalate copolyester containing 12 mole % CHDM was prepared using a 40-mm Werner & Pfleiderer twin screw extruder. The masterbatch was then mixed via pellet-pellet blending with Eastar PETG 6763 polyester and subsequently extruded into 20-mil sheet using a 1.5-inch 24:1 Killion single screw extruder. The properties of the extruded film samples measured including surface resistivity, color, haze, and light transmission are given in Table 1.1. These results show that when the Larostat HTS 905A antistat loading is greater than or equal to 0.67 weight %, then the film is antistatic (i.e. surface resistivity less than 10¹² ohms/sq.) even at 12% relative humidity. The results also show that the film is clear (i.e. haze less than 10%) when the Larostat HTS 905A antistat loading is less than or equal to 1.47 weight %. Thus, there is a specific range of Larostat HTS 905A antistat in copolyesters that will produce a clear and antistatic film.

TABLE 1.1

| | | Surface | | | | |
|---|---|---|---|---|---|---|
| | | Resistivity¹ | | | | |
| | Larostat | (ohms/sq.) | | | | Light |
| | Antistat | 50% | 12% | Color² | Haze³ | Transmission³ |
| Sample | (wt-%) | RH | RH | b | % | (%) |
| 0 | 0 | >10¹⁵ | >10¹⁵ | 0.19 | 0.52 | 90.39 |
| 1 | 0.39 | 10^{14 7} | >10¹⁵ | 0.55 | 0.27 | 91.10 |
| 2 | 0.67 | 10^{10 2} | 10^{11.7} | 0.67 | 0.52 | 91.22 |
| 3 | 0.85 | 10^{10 1} | 10^{11.5} | 0.80 | 0.41 | 90.44 |
| 4 | 1.18 | 10^{9 7} | 10^{11.2} | 0.65 | 1.18 | 90.78 |
| 5 | 1.47 | 10^{9 6} | 10^{11.0} | 1.47 | 4.86 | 89.49 |
| 6 | 1.76 | 10^{9 5} | 10^{10 9} | 1.62 | 41.24 | 85.32 |

¹EOS/ESD S11.11 Surface Resistivity Measurement of Static Dissipative Planar Materials
²ASTM D2244-93 Standard Test Method for Calculation of Color Differences from Instrumentally Measured Color Coordinates
³ASTM D1003-97 Standard Test Method for Haze and Luminous Transmittance of Transparent Plastics

The invention has been described above in detail with particular reference to preferred embodiments thereof, but it will be understood that variations and modifications other than as specifically described herein can be effected within the spirit and scope of the invention. Moreover, all patents, patent applications, provisional patent applications, and literature references cited above are incorporated herein by reference for any disclosure pertinent to the practice of this invention.

We claim:

1. A copolyester composition comprising a copolyester having a melting point less than 250° C. and a quaternary ammonium salt having thermal stability at a temperature greater than 200° C. wherein the quaternary ammonium salt is present in an amount ranging from about 0.6 to about 1.5 weight percent based on the weight of the total composition.

2. The copolyester composition according to claim 1 wherein the quaternary ammonium salt is a quaternary ammonium alkyl benzene sulfonate salt.

3. The copolyester composition according to claim 1 wherein the quaternary ammonium salt is a quaternary ammonium alkane sulfonate salt.

4. The copolyester composition according to claim 1 wherein the quaternary ammonium salt is octyl dimethyl hydroxyethyl ammonium dodecylbenzene sulfonate.

5. The copolyester composition according to claim 1 wherein the quaternary ammonium salt is octyl dimethyl hydroxyethyl ammonium methane sulfonate.

6. The copolyester composition according to claim 1 wherein the quaternary ammonium salt is selected from compounds represented by the following formula: 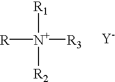
wherein R is a C₂-C₂₂ alkyl, R₁ is selected from the group consisting of C₁-C₂₂ alkyl and an alkyleneoxy radical [—CH₂—C(A)H—O]ₓH, R₂ is selected from the group consisting of C₁-C₃ alkyl and the radical [—CH₂—C(A)H—O]ₓH or R₂ may join together with R₁ to form a morpholino group, R₃ is a radical [—CH₂—C(A)H—O]ₓH, R′ is selected from the group consisting of C₁-C₁₈ alkyl and C₈-C₁₈ alkylphenyl, wherein A is selected from hydrogen, methyl and ethyl, and x is 1.

7. The copolyester composition according to claim 1 wherein the quaternary ammonium salt having thermal stability at a temperature greater than 200° C. is present in an amount ranging from about 0.75 to about 1.5 weight percent.

8. The copolyester composition according to claim 1 wherein said copolyester comprises from one or more diols with two or more dicarboxylic acids, or one or more dicarboxylic acids with two or more diols

9. The copolyester composition according to claim 8 wherein said one or more diols are selected from the group consisting of ethylene glycol, neopentyl glycol, 1,4-cyclohexanedimethanol, 1,2-propanediol, 1,3-propanediol, 1,4-butanediol, 1,6-hexanediol, 1,2-cyclohexanediol, 1,4-cyclohexanediol, 1,2-cyclohexanedimethanol, 1,3-cyclohexanedimethanol, Z,8-bis(hydroxymethyl)-tricyclo-[5.2.1.0]-decane wherein Z represents 3, 4, or 5; diethylene glycol, triethylene glycol, dipropylene glycol, and tripropylene glycol.

10. The copolyester composition according to claim 8 wherein said diols comprise 2 to 18 carbon atoms.

11. The copolyester composition according to claim 10 wherein said diols comprise 2 to 8 carbon atoms.

12. The copolyester composition according to claim 8 wherein said one or more acids are selected from the group consisting of terephthalic acid, isophthalic acid, 1,4-cyclohexanedicarboxylic acid, 1,3-cyclohexanedicarboxylic acid, succinic acid, glutaric acid, adipic acid, sebacic acid, 1,12-dodecanedioic acid, and 2,6-naphthalenedicarboxylic acid.

13. The copolyester composition according to claim 12 wherein said acids comprise one or more of terephthalic acid, naphthalenedicarboxylic acid and 1,4-cyclohexanedicarboxylic acid.

14. The copolyester composition according to claim 13 where said terephthalic acid, naphthalenedicarboxylic acid or 1,4-cyclohexanedicarboxylic acid are independently present at about 80 mole % or above.

15. The copolyester composition according to claim 9 wherein said acids comprise one or more of terephthalic acid, naphthalenedicarboxylic acid and 1,4-cyclohexanedicarboxylic acid and wherein said diols comprise one or more of ethylene glycol and 1,4-cyclohexanedimethanol

16. The copolyester composition according to claim 9 wherein said one of said diols are present independently in the amount of about 10 to about 90 mole %.

17. The copolyester composition of claim 16 wherein said diol is 1,4-cyclohexanedimethanol.

18. The copolyester composition according to claim 17 wherein said 1,4-cyclohexanedimethanol is present at about 10 to about 60 mole %.

19. The copolyester composition according to claim 15 where said terephthalic acid, naphthelanedicarboxylic acid or 1,4-cyclohexanedicarboxylic acid are independently present at about 80 mole % or above.

20. The copolyester composition according to claim 1 wherein said copolyester comprise about 100 mole percent terephthalic acid, about 40 to about 90 mole percent ethylene glycol, and about 10 to about 60 mole percent 1,4-cyclohexanedimethanol.

21. The copolyester composition according to claim 20 wherein said copoolyester comprises about 100 mole percent terephthalic acid, about 65 to about 75 mole percent ethylene glycol, and about 25 to about 35 mole percent 1,4-cyclohexanedimethanol.

22. The copolyester composition according to claim 1 wherein said copolyester comprises about 100 mole percent terephthalic acid, about 40 to about 90 mole percent ethylene glycol, and about 10 to about 60 mole percent neopentyl glycol.

23. The copolyester composition according to claim 22 wherein said copolyester comprises about 100 mole percent terephthalic acid, about 60 to about 80 mole percent ethylene glycol, and about 20 to about 40 mole percent neopentyl glycol.

24. The copolyester composition according to claim 1 wherein said copolyester comprises about 10 to about 50 mole percent isophthalic acid, about 50 to about 90 mole percent terephthalic acid, and about 100 mole percent 1,4-cyclohexanedimethanol.

25. The copolyester composition according to claim 1 wherein said copolyester comprises one or more branching agents selected from the group consisting of trimellitic acid, pyromellitic dianhydride, trimethylolpropane, and pentaerythritol.

26. The copolyester composition according to claim 1 wherein said copolyester has an inherent viscosity of about 0.5 to about 1.5 dl/g as determined in a 60/40 (wt/wt) phenol/tetrachloroethane solution at a concentration of 0.5 grams per 100 ml at 25° C.

27. The copolyester composition according to claim 26 wherein said copolyester has an inherent viscosity of about 0.6 to about 1.0 dl/g as determined in a 60140 (wt/wt) phenol/tetrachloroethane solution at a concentration of 0.5 grams per 100 ml at 25° C.

28. A shaped article prepared from a copolyester composition according to claim 1 selected from the group consisting of films, sheets, fibers, foamed objects and molded objects.

29. The shaped article according to claim 28 wherein said shaped article is a film.

30. The shaped article according to claim 29 wherein said film is produced by a melt blowing process, a solvent casting process, a melt extrusion process, or a melt extrusion process followed by uniaxial or biaxial orientation.

31. The shaped article of claim 28 comprising a multi-layer film wherein at least one layer comprises the composition according to claim 1.

32. The shaped article of claim 28 comprising a sheet further comprising the composition according to claim 1.

33. The shaped article of claim 32 comprising a multi-layer sheet wherein at least one layer comprises the composition according to claim 1.

33. The process for the manufacture of a polyester composition according to claim 1 comprising mixing or blending said quaternary ammonium salt and said copolyester.
